(19) United States
(12) Patent Application Publication
(10) Pub. No.: US 2004/0043370 A1
(43) Pub. Date: Mar. 4, 2004

(54) Animated radio/karaoke device

(76) Inventor: Ben Kau, Arcadia, CA (US)

Correspondence Address: Ben Kau, 127 South Second Ave., #C, Arcadia, CA, 91006, US

(21) Appl. No.: 10/233,822

(22) Filed: Sep. 3, 2002

(51) Int. Cl. G09B 5/00

(52) U.S. Cl. 434/307 A

(57) ABSTRACT

The invention is a radio/karaoke device that consists of a mechanical apparatus featuring one or more characters on it. Such characters may be animals or people. The characters' mouths are linked to a system of transmission that consists of a spring, motor, and oscillating strip. A string attaches the oscillating strip to the motor. When the “motion” function is selected by means of the function switch on the apparatus, the driving circuit inside the mechanical apparatus picks up the frequency of the sound of the radio. Then it causes the motor to rotate at intervals, leading to the characters' periodic mouth movement in synchronization with the sounds of the music. Such movement enhances the entertainment value of the karaoke-singing or radio-listening experience.

### BACKGROUND

1. Field of Invention

This invention relates to a radio/karaoke device which features one or more animated characters that produce movement in synchronization with the sounds of the music played by the device.

2. Description of Prior Art

Currently, the experience of listening to music that a radio plays, or of singing by using a karaoke apparatus, is limited in the scope of entertainment that it provides. These audio appliances offer little visual stimulation to enable the listener or singer to enjoy a more pleasurable experience when utilizing such devices. Rather, these appliances focus exclusively on producing auditory entertainment, without making use of visual enhancements in the form of various featured characters whose movement could add considerable novelty to the musical listening or singing experience.

### OBJECTS AND ADVANTAGES

The object of the animated radio/karaoke device is to make the activity of listening to music or singing karaoke more pleasurable for adults and children, alike. The invention accomplishes this goal by means of a mechanical apparatus that features one or more characters on it. Such characters may be animals or people. The characters' mouths are linked to a system of transmission that consists of a spring, motor, and oscillating strip. A string attaches the oscillating strip to the motor. The driving circuit inside the mechanical apparatus picks up the frequency of the sound of the radio. Then it causes the motor to rotate at intervals, leading to the characters' periodic mouth movement.

The advantages of this device are the following:

(a) While the device is in use as either a radio or karaoke apparatus, the featured character on the device adds interest and entertainment to the music-listening or singing experience by opening and closing its mouth in synchronization with the sounds of the music.

(b) The device can function as an FM radio or karaoke apparatus. In any of these functions, the device can operate either with or without movement by the featured character or characters on it.

### SUMMARY

This invention consists of a mechanical apparatus that features one or more characters on it. Such characters may be animals or people. The characters' mouths are linked to a system of transmission that consists of a spring, motor, and oscillating strip. A string attaches the oscillating strip to the motor. The driving circuit inside the mechanical apparatus picks up the frequency of the sound of the radio. Then it causes the motor to rotate at intervals, leading to the characters' periodic mouth movement. The animated movement of the character or characters makes the activity of listening to music or singing karaoke more pleasurable for adults and children, alike.

### DRAWINGS

Drawing Figures

The following numbers correspond to specific drawings of the invention:

FIG. 1 shows the invention from a perspective view

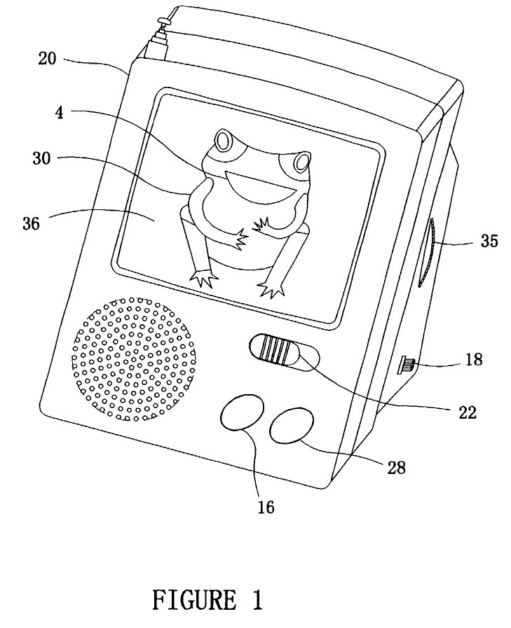

FIG. 2 offers a view of the invention's driving mechanism

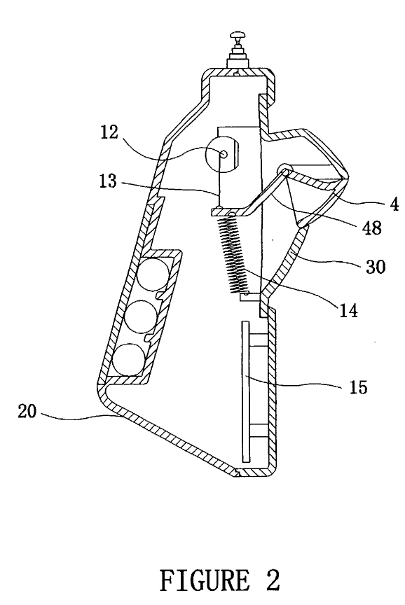

FIG. 3 shows a block diagram of the invention

FIG. 4 is a diagram of the invention's radio circuitry

### REFERENCE NUMERALS IN DRAWING

4 character's mouth

12 motor

13 string

14 spring

15 circuit board

16 “reset” button

18 frequency reception adjustment knob

20 mechanical apparatus

22 function switch

28 “scan” button

30 character

35 volume control wheel

36 display window

48 oscillating strip

50 sound control circuit

52 radio reception circuit

54 AUX (CD, tape) circuit

56 amplifier

58 speaker

60 sound frequency control circuit

70 output circuit

80 driving mechanism

### DETAILED DESCRIPTION

### DESCRIPTION OF PREFERRED EMBODIMENTS

This invention consists of a mechanical apparatus 20 that features a display window 36. The display window 36, in turn, features a character 30 that is three-dimensional. The “reset” button 16 and “scan” button 28 are also located on the surface of the apparatus 20. These buttons allow for the operation of the radio. Additionally, there is a function switch 22 that features three options. When the “off” option is chosen, the power is off. If the “radio” option is chosen, then the apparatus 20 only plays music from the FM radio. If the “motion” option is chosen, then the music from the FM radio plays to the accompaniment of synchronized movements from the mouth 4 of the featured character 30 on the display window 36 of the apparatus 20. A driving mechanism 80 is connected to the mouth 4 of the character 30 featured on the mechanical apparatus 20. The mouth 4 of the character 30 is linked to an oscillating strip 48. By means of a string 13, this oscillating strip 48 is attached to a motor 12. The underside of the oscillating strip 48 is attached to a spring 14 that stabilizes the strip 48 when the strip 48 is in operation. This enables the character's mouth 4 to open and close when the motor 12 rotates.

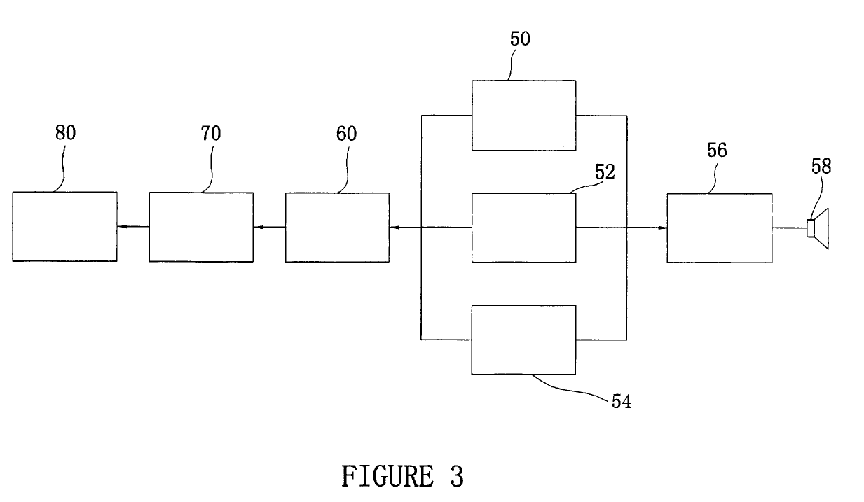

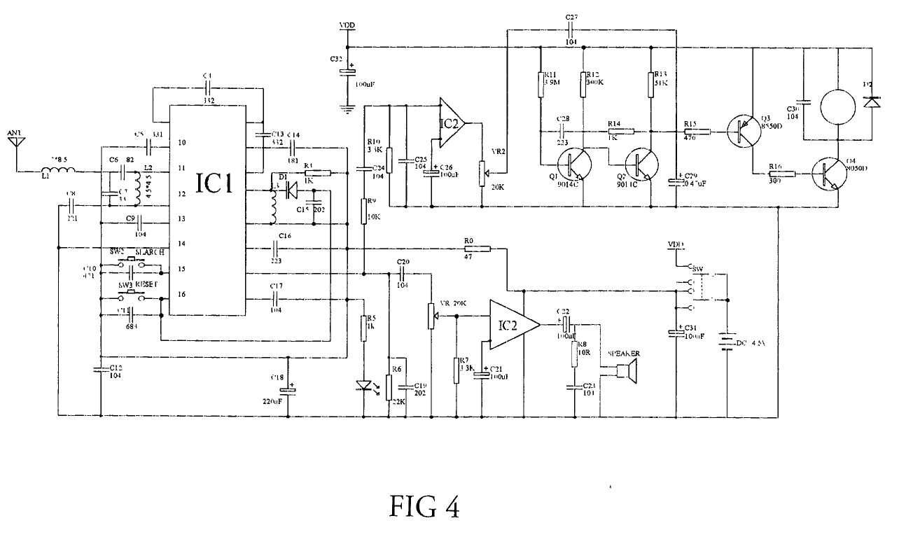

Operation—FIGS. 3 and 4

FIG. 3 shows the electrical circuitry of this invention. The circuitry system includes a sound control circuit 50, a radio circuit 52, and an AUX (CD, tape) circuit 54. The circuits are each linked to an amplifier 56 that enables a speaker 58 to produce sound. Additionally, the circuits are linked to a sound frequency control circuit 60 that picks up frequency signals. These signals are transmitted by the output circuit 70. The output circuit 70 then activates different driving mechanisms 80 to create movement of the character's mouth 4.

A diagram of the radio reception circuit 52 is presented in FIG. 4. A single-chip integrated circuit IC1 composes signal reception of FM frequencies. IC2 amplifies the sound signals that are received prior to their transmission through the speaker. The sound signals are transmitted to IC2 for amplification. The sound signals that have been amplified are then reamplified by the crystal that is composed from Q1 to Q4, for analysis of frequency signals to activate the motor's rotation.

Conclusion

In conclusion, this invention is designed to make the activity of listening to music or singing karaoke more pleasurable for adults and children, alike. The invention accomplishes this goal by means of a mechanical apparatus that features one or more characters on it. Such characters may be animals or people. Through a system of transmission that consists of a spring, motor, and oscillating strip, and by means of a driving circuit inside the mechanical apparatus, the characters' mouths produce periodic movement in synchronization with the sounds of the music being played by the device.

I claim:

1. A radio/karaoke device which features one or more animated characters that produce movement in synchronization with the sounds of the music played by said device. Said device includes a three-dimensional character, that may be in the form of a person or animal, featured on the surface of said device. Said character consisting of a moving mouth. Said mouth being linked to specific mechanisms—namely:

2. A driving mechanism connected to said mouth of said character featured on said device. Said mouth of said character being linked to an oscillating strip. Said oscillating strip is attached to a motor by a string. Additionally, said oscillating strip is attached to a spring. This enables said mouth of said character to open and close when said motor rotates, and

3. A circuitry system that includes a sound frequency control circuit that picks up frequency signals that are transmitted by an output circuit. Said output circuit activating different driving mechanisms to create movement of said mouth of said character.
